(19) United States
(12) Patent Application Publication
(10) Pub. No.: US 2011/0221647 A1
(43) Pub. Date: Sep. 15, 2011

(54) Multi-Element Folded-Dipole Antenna

(76) Inventor: Wayne A. Freiert, Canandaigua, NY (US)

(21) Appl. No.: 12/889,899

(22) Filed: Sep. 24, 2010

Related U.S. Application Data
(60) Provisional application No. 61/313,401, filed on Mar. 12, 2010.

(51) Int. Cl. H01Q 19/06; H01Q 9/26

(52) U.S. Cl. 343/803; 343/833

(57) ABSTRACT

A multi-element directional antenna having three-wire elements in the form of square open loops. The three wires of each of the loops are arranged close together and aligned along the direction of radiation of the antenna. Each of the loops is open—that is, the wires are split, leaving a gap between the ends of the elements. In a two-element embodiment, an active driven element and a parasitic element are aligned and spaced apart along an axis of the direction of radiation of the antenna. One of the wires of the driven element is split in half, such that the driven element forms a three-wire folded dipole. Additional active or parasitic elements can be added.

### REFERENCE TO RELATED APPLICATIONS

This application claims one or more inventions which were disclosed in Provisional Application No. 61/313,401, filed Mar. 12, 2010, entitled “Multi-Element Folded-Dipole Antenna”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of high frequency (HF) and very high frequency (VHF) antennas. More particularly, the invention pertains to multi-element wire antennas using multiple-wire elements.

2. Description of Related Art

The half-wave dipole antenna (70), as shown in FIG. 7, is commonly used throughout the radio spectrum. In the high frequency (HF) radio spectrum, 3-30 MHz, dipole antennas are typically made of wire, with the total length of the antenna being one-half wavelength (λ/2). The dipole is divided into two quarter-wavelength halves (71)(72), usually separated by an insulator (73). The two conductors of a feedline (74) is connected to the two halves (71) and (72) of the dipole (70). The feedline (74) is shown as a balanced feed ladder line in the figures, but it will be understood that other feedlines, such as coaxial cable, can also be used. Sometimes a balanced-to-unbalanced line transformer (balun) is used at (73) in place of a simple insulator, to interface the unbalanced coaxial cable to the balanced dipole antenna. The free space impedance of a simple dipole is approximately 76Ω.

FIG. 8 shows a folded dipole antenna (75), which is also one half wavelength in length. A continuous second wire (76) is added in parallel to, but spaced a small distance apart from, the two halves of the basic dipole (71)(72). The ends of wire (76) are connected to the outside ends of wires (71) and (72). The free space impedance of a two wire folded dipole is approximately 300Ω.

FIG. 9 shows a three-wire folded dipole antenna (77), which is also one half wavelength in length. In this antenna, two continuous wires (76) and (78) are added in parallel to, but spaced a small distance apart from, the two halves of the basic dipole (71)(72). The ends of wires (76) and (78) are connected together as well as to the outside ends of wires (71) and (72). The free space impedance of a two wire folded dipole is approximately 570Ω.

When suspended horizontally with the wire parallel to the ground and distant from any conducting structures which might distort the pattern, all dipole antennas (70), (75) and (77) are essentially bi-directional, radiating most of their energy in a pattern at right angles to the length of the wire. This can be seen in the azimuth radiation pattern plot shown in FIG. 5a, which shows antenna radiation as seen from a position directly above the antenna, with the wire running from 90° to 270° on the graph. Thus, an observer at 0° or 180° would see the same radiation strength. This is considered a 0 dB front-to-back ratio (there being essentially no front or back). FIG. 5b shows the radiation in elevation—in other words, a plot of radiation as if one were standing at the end of the wire looking along the length of the antenna. As can be seen on FIG. 5b, a dipole radiates mostly horizontally, but there is a significant amount of radiation upward (90°) as well.

A common multi-element directional antenna is the “Yagi” (or “Yagi-Uda”) beam antenna (80), shown in FIG. 10. A Yagi antenna can be made with wire elements, but more commonly uses linear rigid elements such as aluminum tubing or the like. One element (the “driven element”) (81) is usually in the form of a half-wave dipole electrically connected to the radio by a feed line (74) such as coaxial cable or, as shown here, ladder line. In addition to the driven element (81), the Yagi may have two or more elements which are not directly connected to the radio, which are known as “parasitic elements”, all mounted on a horizontal boom (84) which supports the elements and allows the beam to be rotated.

A “reflector” element (82) is typically longer than the driven element, and acts to direct the signal (or received pattern) toward the driven element (81) along the axis of the beam. A “director” element (83) is typically shorter than the driven element (81) and acts to direct the signal away from the driven element (81) along the axis of the beam. Note that the size differences between the elements are exaggerated in FIG. 10—the actual difference in length from element to element would be on the order of 5%.

The most common arrangement for the elements of a Yagi antenna on the high frequency (HF) bands (3-30 MHz), as depicted in FIG. 10, would be a three-element beam having one reflector (82), a driven element (81), and a director element (83), with all of the elements mounted parallel to ground. A four-element beam would add a second director, five-element beams would have three directors, and so on. Two-element beams, with only reflector and driven elements, are more common on the lower frequency bands such as 20 Meters (14 MHz) or 40 Meters (7 MHz), where element and boom lengths become very large.

FIG. 6a shows the azimuth radiation graph for a typical two-element HF Yagi. The graph is plotted with the boom (84) running in the direction 180°-0°, with the reflector (82) on the 180° end (“back”) and the driven element (81) toward 0° (“front”). As can be seen, the Yagi radiates more energy in the forward or front direction, although there is still a significant amount of radiation off the rear of the antenna. The front-to-back ratio for this two-element Yagi would be less than 9 dB. This can also be seen in the elevation radiation graph in FIG. 6b—there is more radiation to the right (forward) direction 0° than to the left (rearward) 180°. Also, there is less radiation upward 90° than in a dipole.

A log-periodic antenna is a beam antenna having a number of driven elements, usually rigid poles as in a Yagi, in which the driven elements are of graduated size so as to cover a wide frequency range. Home VHF television receiving antennas are often of the log-periodic type.

The antenna design that is closest to the antenna of the present invention is the Cubical Quad design, first developed by Clarence Moore in the early 1940's at shortwave broadcast station HCJB in Peru, as a way of minimizing corona discharge at high altitude. Moore received U.S. Pat. No. 2,537,191 in 1951 on a Quad design in which each element is a two-wavelength double loop (or more, using an even number of turns in each loop).

The two-element Cubical Quad (90) shown in FIG. 11 has elements (91)(93) in the form of square loops, usually of a single conductor made of wire supported on spreaders (94) mounted to a boom (95). The spreaders (94) are insulated from the wires, and are often made of insulating material such as bamboo or other wood. Some variations on the Quad antenna use triangular or round loop elements instead of square loops, but are otherwise similar.

As with the Yagi, the elements of a two-element Quad are usually a reflector and a driven element, with director elements being added for three- or more-element Quads. Most Quad antennas today have single wire loops in which the length of wire of the driven element (91) is approximately one-quarter wavelength (λ/4) on each side, for a total length of one wavelength around the loop. The loop of wire in the reflector (93) is slightly longer, and if there are any, the wire lengths of director elements would be shorter.

The driven element (91) is fed by splitting the loop of wire at an insulator (92), to which feedline (74) is connected. The insulator (92) can be mounted at a spreader (94) as shown in the FIG. 11, or in the wire loop half-way along one side. The Quad can be mounted with the spreaders (94) horizontal and vertical in a “+” configuration as shown, or the spreaders (94) can be mounted in an “X” arrangement with the wires in the loop elements (91)(93) horizontal and vertical.

Because the of the need for a resonant antenna, the dimensions of the antennas are proportional to the frequency band(s) on which they are designed to operate, with the basic driven part of each of the antennas usually being either a half-wavelength dipole or a full-wavelength loop. For example, the elements of a three-element Yagi antenna for the 15 Meter (21 MHz) amateur band would be approximately 22 feet long for the driven element, 23 feet 4 inches for the reflector, and approximately 21 feet for the reflector, on a boom approximately 18 feet long. The driven element for a Cubical Quad for 15 meters would have elements with 46.5 feet of wire on a square with a diagonal dimension of about 16 feet. The reflector dimensions for the Quad would be 48 feet and approximately 17 feet, respectively.

On the high frequency bands (3-30 MHz), these dimensions can be prohibitively large for some home applications, and can have a high visual impact which makes them unsuitable or undesirable in residential settings.

### SUMMARY OF THE INVENTION

The invention provides a multi-element directional antenna having three-wire elements in the form of square open loops. The three wires of each of the loops are arranged close together and aligned along the direction of radiation of the antenna. Each of the loops is open—that is, the wires are split, leaving a gap between the ends of the elements. In a two-element embodiment, an active driven element and a parasitic element are aligned and spaced apart along an axis of the direction of radiation of the antenna. One of the wires of the driven element is split in half, such that the driven element forms a three-wire folded dipole. Additional active or parasitic elements can be added.

### BRIEF DESCRIPTION OF THE DRAWING

FIG. 1 shows a perspective view of the elements of the antenna.

FIG. 2 shows a detail of the driven three-wire folded dipole element of the invention.

FIG. 3 shows a detail of a parasitic three-wire element of the invention.

FIGS. 4a and 4b show azimuth and elevation plots of radiation from the antenna of the invention.

FIGS. 5a and 5b show azimuth and elevation plots of radiation from a dipole antenna of the prior art.

FIGS. 6a and 6b show azimuth and elevation plots of radiation from a Yagi antennaof the prior art.

FIG. 7 shows a dipole antenna of the prior art.

FIG. 8 shows a folded dipole antenna of the prior art.

FIG. 9 shows a three-wire folded dipole antenna of the prior art.

FIG. 10 shows a Yagi beam antenna of the prior art.

FIG. 11 shows a cubical quad antenna of the prior art.

### DETAILED DESCRIPTION OF THE INVENTION

This invention is a radio frequency antenna that is designed to transmit and receive radio frequency energy in the high frequency and very high frequency radio spectrum. The design is scalable for operation at any frequency, and is preferably designed for use in the high frequency (HF) and low very high frequency (VHF) portions of the spectrum, between 10.0 MHz and 150 MHz. The antenna may be designed for use outside this range, however it will be understood that an antenna designed to operate below 10 MHz would be large, increasing the required supporting structure, and an antenna designed to operate above 150 MHz would require precise manufacturing tolerances.

The antenna design is such that the size of the antenna is significantly smaller than other antennas such as Yagi beams or Cubical Quads designed to operate on the same frequency. In addition, the antenna design is very efficient, has high gain, has high front to back gain performance, has a reasonable operating bandwidth and has impedance characteristics that are easily interfaced with most modern transmitting and receiving equipment. Also, this design permits the antenna to be operated at a relatively low height above the ground.

The design of this antenna therefore provides a much lower visual profile then current antenna designs. Consequently, this antenna is visually less apparent when compared to current antennas of other design.

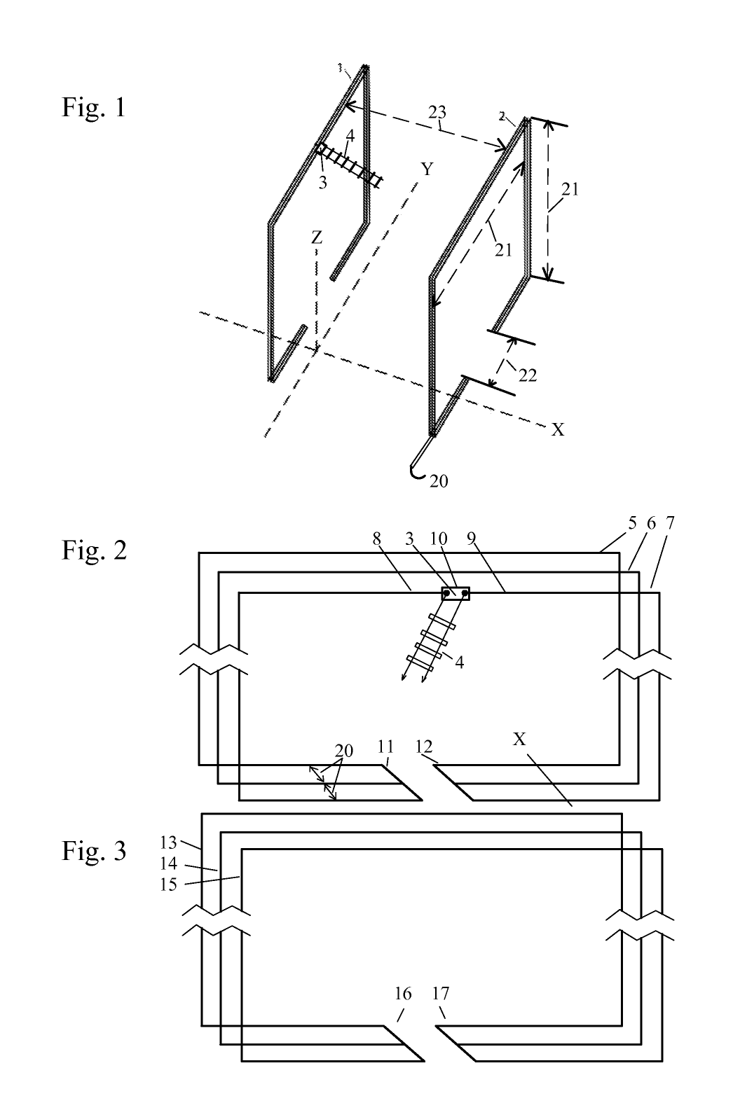

Referring to FIG. 1, the basic antenna of the invention consists of two radiating elements—a driven element (1) shown in detail in FIG. 2 and a parasitic element (2), acting as a director, shown in detail in FIG. 3—spaced apart along an axis (x) running parallel to a line drawn through the centers of the elements. The antenna is directional along this x-axis. Each element is a three wire square open loop on a plane along the z-axis orthogonal to the x-axis, thus the total length of the element is approximately one-half wavelength (λ/2), half the size of the single-wire elements in a Cubical Quad. The size and material of the wire and whether the wire is insulated or bare can be varied within the teaching of the invention and will affect the required length of the elements. A wire typically has a solid or stranded circular cross section, other types of conductors can be used having non-circular cross section shape, for example tubing, channel, square or rectangular cross section, etc.

In more complex embodiments, additional driven elements or additional parasitic elements can be added to the design of this invention to change the performance characteristics of the antenna. The trade-off would be increased antenna length in the direction of the x-axis.

The driven element (1) has one wire of the three wire folded dipole split in halves, such that the loop forms a three-wire folded dipole excited by a radio frequency source at a feed point in the center (3) of that wire via a feed line (4), which is preferably a balanced feed such as twinlead or ladder line. The parasitic element (2) becomes excited through the field generated by the driven element to provide directivity and gain. It will be understood that while the terms “excited” and “driven” are used in the description, the antenna of the invention is not limited to transmission, and will work equally well for receiving, where the driven element is coupled by the feedline to a receiver, or for both transmitting and receiving using a transceiver.

The three wire folded dipole driven element, as shown in FIG. 2, is made up of three wires (5), (6) and (7) spaced close together—the gap (20) between the wires being a small fraction of a wavelength, preferably approximately one-thousandth of a wavelength (0.001λ) (or less than an inch, at a 21 MHz design frequency)—and arranged in a single plane (X), aligned along the direction of radiation of the antenna.

One of the three wires is split at the center (3) into two equal halves (8) and (9) by insulator (10). The two conductors of the feedline (4) are attached to the half-wires (8) and (9) at the insulator (10). The split wire is here shown as wire (7), the wire closest to the parasitic element (2), although it will be understood that any one of the three wires could be split within the teachings of the invention.

The ends of the wires (5), (6) and (7) are connected together at connections (11) and (12), with (11) and (12) are separated by a gap (22) of about four hundredths of a wavelength (0.04λ) or less. The size of the gap can be varied within the teaching of the invention, which will affect impedance, gain and front-to-back ratio.

The three wire parasitic element (2), as shown in FIG. 3, is similar, except that the three wires (13), (14) and (15) are continuous from end (16) to end (17). The driven (1) and parasitic (2) elements are spaced apart by approximately one tenth of a wavelength (0.10λ).

The wires of the antenna are supported by a structure (not shown), insulated from the wires, which holds the wires in the specified shape and locations. The supporting structure can be a boom and “X” shaped fiberglass or bamboo stretchers, as is commonly used in Cubical Quad antennas, or other forms of antenna supports known to the art can be used. On low frequency applications, where the size of the elements is very large, a non-rotating version of the antenna could be made by stretching the wire loops out by guy wires at the corners attached to trees or other structures, and no boom would be needed. If the frequency is high enough so that the loop sides are small enough to allow such a structure, the “wires” could be in the form of rigid tubing or channels, as noted above, such that the loop elements could be self-supporting without the need for other internal structure or stretchers.

The shape, dimensions and spacing of the radiating elements for this antenna result in forward gain, favorable front to back gain performance characteristics, high efficiency, and reasonable operating bandwidth. The dimensions of this antenna are considerably smaller than prior art and this antenna has a much shorter turning radius.

The spacing (20) between the wires within the elements, the size (21) of the sides of the square elements, the spacing of the gap (22) between the ends of each of the wires and the spacing (23) between the driven and parasitic elements can be varied to adjust the impedance, gain and front-to-back ratio of the antenna.

The impedance of the antenna can be easily interfaced with most modern transmitting and receiving equipment, which is typically about 50Ω. When the three wire folded dipole is shaped into an open square configuration, the impedance becomes lower than the 560Ω free-space impedance of a straight three-wire dipole. When a three wire parasitic element is brought into proximity of the driven element, the impedance of the three wire folded driven element is lowered further. By adjusting the element spacing (23) the impedance can be brought to a value that can be easily interfaced with equipment designed for a 50Ω antenna load.

The design of this antenna is scalable and particularly useful for antennas operating in the high frequency and very high frequency radio spectrum. As an example, Table 1 denotes the dimensions of an antenna designed to operate on the amateur 15 Meter band with a design center frequency of 21.3 MHz and a design mounting height of approximately 30 feet. It will be understood that as the design mounting height is changed or if there are objects within the near field of the antenna, the impedance, front-to-back ratio and gain of the antenna will be effected, and the dimensions can be altered accordingly.

TABLE 1
Dimensions for 21.300 MHz Antenna,
using 12 AWG copper insulated wire.

| | | Dimension | Dimension |
|---|---|---|---|
| Description | Ref. No | (Inches) | (wavelength) |
| Distance between the Folded Dipole | 20 | 0.75″ | 0.001 * λ |
| wires. | | | |
| Dimension of each square element | 21 | 75.25″ | 0.136 * λ |
| side. | | | |
| Total length of each wire (λ/2) | — | 277.875″ | 0.5 * λ |
| Distance between the ends of each | 22 | 23.125″ | 0.04 * λ |
| element. | | | |
| Distance between the driven element | 23 | 54.5″ | 0.10 * λ |
| and the parasitic element. | | | |

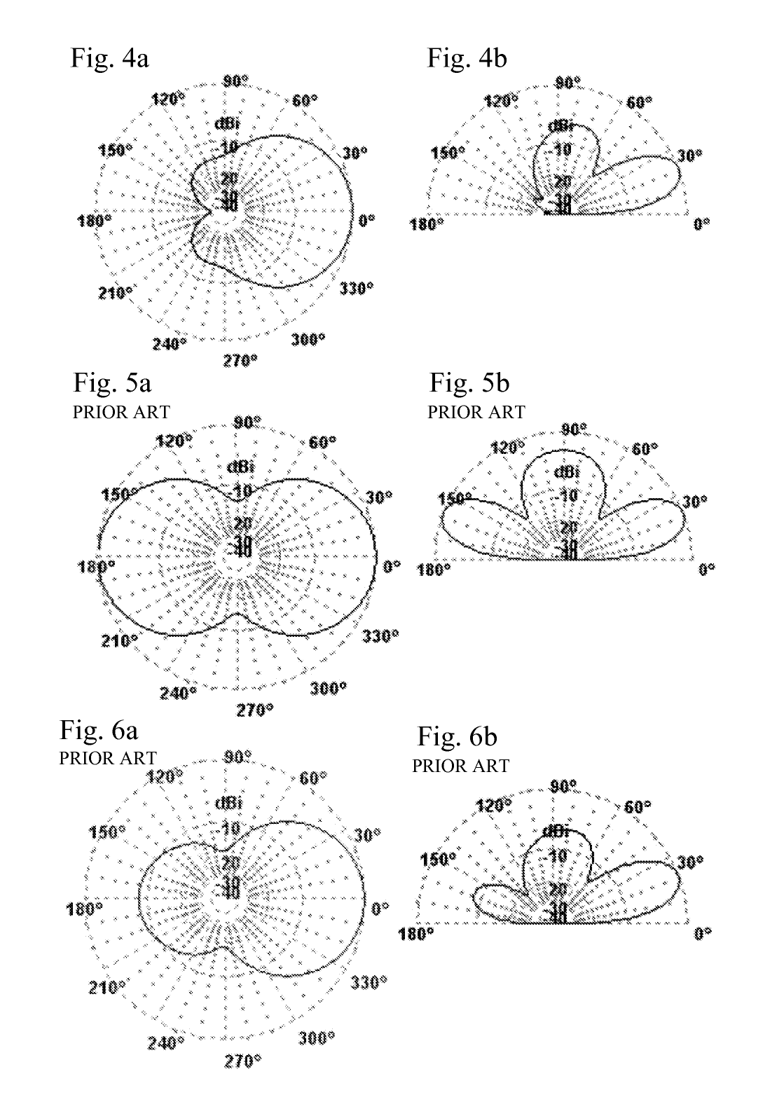

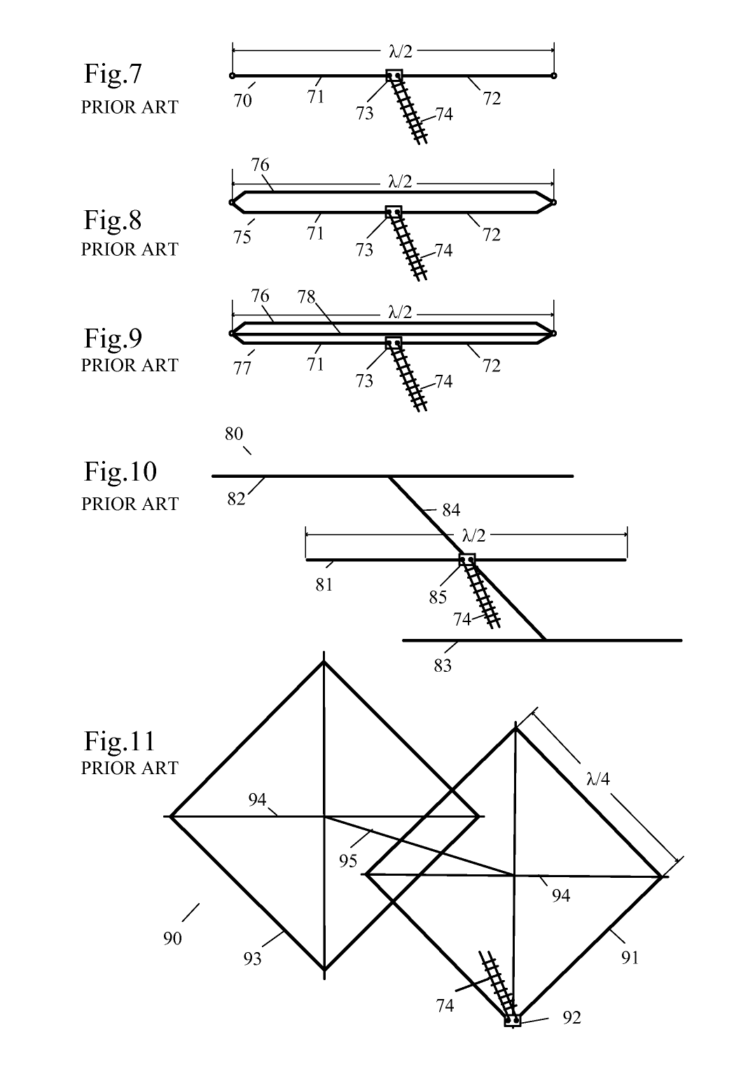

FIG. 4a shows a graph of the calculated azimuth radiation pattern for a two-element antenna constructed according to the teachings of the invention. FIG. 4b shows the elevation graph. As can be seen in comparison to the Yagi in FIGS. 6a and 6b, the antenna of the invention shows a superior directivity, with less radiation directed toward the back of the antenna pattern (180°) or upward (90° elevation), so the antenna would have a superior front-to-back ratio and more gain.

The antenna may be expected to have a forward gain equal or greater than 10 dBi, a front-to-back ratio equal or greater than 25 dB, an efficiency equal to or greater than 90%, and a Standing Wave Ratio (SWR) when fed with 45 feet of 370 ohm balanced feed line equal to or less than 1.25:1.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A multi-element antenna directional along an axis, comprising:
a) a three-wire folded dipole driven element comprising:
i) three wires, each wire having a first end and a second end and a length between the first end and second end, the lengths of the three wires being equal;
ii) the three wires of the driven element being spaced apart and aligned on a plane parallel to the axis of the antenna;
ii) the three wires of the driven element being arranged in a square having four equal sides on a plane orthogonal to the axis of the antenna;
iii) the first ends of all three wires of the driven element being connected together;
iv) the second ends of all three wires of the driven element being connected together;
v) one of the three wires of the driven element forming a dipole with an insulator splitting the wire into two equal halves at a midpoint of the length of the dipole;
b) a three-wire parasitic element spaced a distance along the axis of the antenna from the driven element, comprising:
i) three wires, each wire having a first end and a second end and a length between the first end and second end, the length of the three wires of the parasitic element being equal to the length of the wires of the driven element;
ii) the three wires of the parasitic element being spaced apart and aligned on a plane parallel to the axis of the antenna;
ii) the three wires of the parasitic element being arranged in a square having four equal sides on a plane orthogonal to the axis of the antenna and parallel to the plane of the square of the driven element, the sides of the parasitic element being aligned with the sides of the driven element;
iii) the first ends of all three wires of the parasitic element being connected together;
iv) the second ends of all three wires of the parasitic element being connected together; and
c) a feed point coupled to the dipole of the driven element at the insulator.

2. The antenna of claim 1, in which the first ends of the three wires of the driven element are spaced apart from the second ends of the three wires of the driven element by a gap equal to approximately four hundredths of a wavelength (0.04λ).

3. The antenna of claim 1, in which the first ends of the three wires of the parasitic element are spaced apart from the second ends of the three wires of the parasitic element by a gap equal to approximately four hundredths of a wavelength (0.04λ).

4. The antenna of claim 1, in which the lengths of the three wires of the driven element are approximately one half wavelength (λ/2) at a design frequency for the antenna.

5. The antenna of claim 1, in which the lengths of the three wires of the parasitic element are approximately one half wavelength (λ/2) at a design frequency for the antenna.

6. The antenna of claim 1, in which the three wires of the driven element are spaced apart a distance of approximately one-thousandth of a wavelength (0.001λ) at a design frequency for the antenna.

7. The antenna of claim 1, in which the three wires of the parasitic element are spaced apart a distance of approximately one-thousandth of a wavelength (0.001λ) at a design frequency for the antenna.

8. The antenna of claim 1, in which the driven element and the parasitic element are spaced apart approximately one tenth of a wavelength (0.1λ) at a design frequency for the antenna.

9. The antenna of claim 1, further comprising at least one additional parasitic element, spaced a distance along the axis of the antenna from the driven element.

10. The antenna of claim 1, further comprising at least one additional driven element, spaced a distance along the axis of the antenna from the driven element.

11. The antenna of claim 1, in which the wire of the folded dipole in the driven element is the wire closest to the parasitic element.
